(19) United States
(12) Patent Application Publication
(10) Pub. No.: US 2007/0277360 A1
(43) Pub. Date: Dec. 6, 2007

(54) BLADE CHANGER APPARATUS

(76) Inventors: Stanley Frank POGORZELSKI, Simcoe (CA); Todd Francis Knechtel, Delhi (CA)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/739,263

(22) Filed: Apr. 24, 2007

(30) Foreign Application Priority Data
Apr. 27, 2006 (CA) 2,545,093

(51) Int. Cl. B25B 27/14

(52) U.S. Cl. 29/281.1; 37/231

(57) ABSTRACT

Apparatus for mounting a blade on an ice resurfacing machine is disclosed and comprises a frame, a tray and a jack. The frame is wheeled for movement across a floor surface. The tray is for supporting the blade, has an upper side and is capable of supporting said blade during use of the apparatus so that the blade from front to rear edges thereof extends at an acute angle to the floor, at which angle said blade is suitably orientated for attachment to said machine. The jack is mounted on the frame, supports the tray and is adapted to move the tray between a lowered position, whereat the blade can be arranged on the tray at said acute angle, and an elevated position, whereat the blade can be secured to said machine when the apparatus is operatively positioned beneath said machine.

### FIELD OF THE INVENTION

This invention relates to devices or equipment for changing sharp blades such as the elongate, sharp blades of ice resurfacing machines.

### BACKGROUND OF THE INVENTION

Mechanized and drivable ice resurfacing machines, such as the machines sold by Frank J. Zamboni and Co. Inc. under the trade-mark ZAMBONI, have been used in arenas both in Canada and the United States for many years. These machines employ a large, elongate steel blade that is mounted under the machine and that has a very sharp leading edge to scrape the ice surface. It will be appreciated that these blades must be replaced from time to time, as they become worn. In order to protect installers and handlers of these blades, they are commonly transported or handled with a protective transportation sheath extending over the sharp blade edge, this sheath commonly being made with wooden strips.

### SUMMARY OF THE INVENTION

A blade changer apparatus for use with an ice resurfacing machine and a blade for said machine forms one aspect of the invention. This apparatus comprises a tray arrangement and a jack mechanism. The tray arrangement is for supporting at least said blade. The jack mechanism is adapted to move the tray arrangement between a lowered position and an elevated position whereat, when said blade is operatively supported by said tray arrangement and said jack mechanism is operatively positioned beneath said machine, said tray arrangement supports said blade substantially at an acute angle to a horizontally extending surface on which said apparatus rests and at a suitable height for securing said blade to said machine for use.

According to another aspect, the tray arrangement can be adapted to support both said blade and a sheath to which said blade is releasably secured for handling, said blade and sheath forming a blade/sheath combination, and wherein, before said tray arrangement is moved to said elevated position, said blade can be detached and separated from said sheath and arranged at said acute angle.

According to another aspect, the tray arrangement can be adapted to permit, when said blade is released from said sheath, said blade to be tipped upright on its edge to an upright position, to permit mounting bolts to be fitted through or removed from said blade.

According to another aspect, the apparatus can further comprise a stabilizer positionable with respect to the tray arrangement to form a guard against which said blade can be rested when it has been tipped to the upright position.

According to another aspect, the tray arrangement can include a blade rest movable between a supporting position and a non-supporting position. In the supporting position, the blade rest overlies a supporting surface of a blade/sheath holding section of the tray arrangement, at which position, the blade can be tipped downwardly from the upright position and at which position the blade rest supports said blade in an angular orientation relative to horizontal such that, when the jack mechanism is operatively positioned beneath said machine and the tray arrangement is raised to the elevated position, said blade is disposed substantially at the position the blade occupies when secured to said machine in use. In the non-supporting position, the blade rest does not extend over the holding section. The blade/sheath combination can be placed flat on said holding section when the blade rest is in its non-supporting position.

According to another aspect, the blade rest can be hingedly secured to said holding section for movement between its supporting and non-supporting positions.

According to another aspect, the jack mechanism can comprise a pair of scissor jacks, mechanically coupled to one another for joint actuation in order to move the tray arrangement between said lowered position and said elevated position.

According to another aspect, the jack mechanism can comprise a pair of hydraulic jacks, fluidly coupled to one another for joint actuation in order to move the tray arrangement between said lowered position and said elevated position.

According to another aspect, the jack mechanism can be provided with wheels and handles and be adapted for rolling movement in the manner of a wheelbarrow.

According to another aspect, the handles and wheels can support said jack mechanism in its operative position.

According to another aspect, the jack mechanism can be provided with wheels and handles and be adapted for rolling movement in the manner of a cart.

According to another aspect, the wheels can support said jack mechanism in its operative position.

A blade changer apparatus for mounting an elongate blade on an ice resurfacing machine forms another aspect of the invention. This apparatus comprises a wheeled base frame, an elongate tray arrangement and a jack arrangement. The base frame is wheeled for movement across a horizontally extending surface. The tray arrangement is for supporting the blade. The tray arrangement includes an upper side, with a length and a width, and has opposite ends between which said upper side extends in a horizontal direction. The blade is arranged on said upper side so that the length of said blade extends in the lengthwise direction of said tray arrangement during use of said apparatus. The tray arrangement is capable of supporting said blade during use of the apparatus so that the blade from front to rear edges thereof extends at an acute angle to a horizontal plane at which angle said blade is suitably orientated for attachment to said machine. The jack arrangement is mounted on said base frame, supports said tray arrangement and is adapted to move the tray arrangement between a lowered position at which the blade can be arranged on said tray arrangement at said acute angle to a horizontal plane, and an elevated position at which said blade can be secured to said machine when said apparatus is operatively positioned beneath said machine.

According to another aspect, the tray arrangement can include a blade rest movable between a blade supporting position overlying said upper side and a non-supporting position where the blade rest does not extend over said upper side. During use of this apparatus, said blade can be placed on top of the blade rest when the latter is in said supporting position and thereby orientated at said acute angle for attachment to said machine.

According to another aspect, the tray arrangement can include a blade holding section which is mounted on and connected to said jack arrangement and said blade rest can be hingedly secured to a rear side of said blade holding section for pivotal movement between its supporting and non-supporting positions.

According to another aspect, the acute angle can be less than 30 degrees.

According to another aspect, the base frame can be elongate in a direction extending between left and right ends thereof, and said jack arrangement can comprise a pair of spaced-apart jacks operatively coupled to a single drive mechanism for joint actuation, each jack being positioned adjacent a respect one of said left and right ends.

A blade changer apparatus for mounting an elongate blade on a machine forms another aspect of the invention. This apparatus comprises a support frame, a tray arrangement and a jack arrangement. The support frame is wheeled for movement over a horizontally extending surface. The tray arrangement is adapted for supporting said blade and a sheath to which said blade is releasably secured for transport and handling purposes, said blade and sheath together forming a blade/sheath combination. The tray arrangement includes a holding section and a blade rest. The holding section has a upper side extending horizontally between left and right ends of the holding section and adapted to hold said blade/sheath combination. The blade rest is movable between a blade supporting position and a non-supporting position. In the supporting position, the blade rest overlies said upper side, extends at an acute angle to said horizontally extending surface and can be used to support said blade at said acute angle during the mounting of the blade on said machine. In the non-supporting position, the blade rest does not overlie said upper side. The jack arrangement is mounted on said support frame and is adapted to support said tray arrangement. The jack arrangement is connected to said holding section and is capable of moving said tray arrangement between a lowered position at which said blade/sheath combination can be arranged on said holding section, and an elevated position used for securing said blade to said machine.

According to another aspect, the blade rest can be hingedly secured to a rear side of said holding section and be pivotable between said blade supporting position and said non-supporting position.

According to another aspect, the apparatus can include a stabilizer detachably mountable on a front side of said holding section, said stabilizer in use providing a vertically extending support against which said blade can be rested when said blade is pivoted to an upright position in order to insert mounting bolts through holes on the blade.

According to another aspect, the jack arrangement can include a pair of spaced-apart scissor jacks and a continuous drive chain and crank arrangement for operating said scissor jacks simultaneously.

According to another aspect, the acute angle to said horizontally extending surface can be in the range of 15 to 30 degrees, with said wheeled support frame resting on the horizontally extending surface.

According to another aspect, said support frame can have two wheels mounted at opposite ends thereof and be provided with handles that extend rearwardly and upwardly from the support frame, whereby said apparatus is adapted for rolling movement in a manner similar to that of a wheelbarrow.

Advantages, features and characteristics of the present invention, as well as methods of operation and functions of the related elements of the structure, and the combination of parts and economies of manufacture, will become more apparent upon consideration of the following detailed description with reference to the accompanying drawings, the latter being briefly described hereinafter.

### BRIEF DESCRIPTION OF THE DRAWINGS

FIG. 1 is a front elevational view of a blade changer apparatus constructed according to a preferred embodiment of the invention;

FIG. 2 is a rear elevational view of the structure of FIG. 1, with internal components shown in phantom outline;

FIG. 3 is a view along section 3-3 of FIG. 2;

FIG. 4 is an enlarged view of a portion of FIG. 3, with a blade rest shown in a non-supporting position, a new or replacement blade with its protective sheath placed in the elongate tray of the blade changer and a stabilizer positioned with respect to the tray to form a guard;

FIG. 5 is a view similar to FIG. 4, with the blade released from the sheath and disposed in an upright position against the guard, and with bolts fitted through corresponding holes formed in the blade;

FIG. 6 is a view similar to FIG. 5, with the blade rest disposed in its supporting position and the blade resting thereupon;

FIG. 7 is a view similar to FIG. 3, with the blade shown as in FIG. 6 and the rear end of the apparatus raised off the ground for transport;

FIG. 8 is a view similar to FIG. 7, with the jack mechanism shown in its operative position and the tray shown in its lowered position;

FIG. 9 is a view similar to FIG. 8, with the tray shown in its elevated position;

FIG. 10 is a rear perspective view of a blade changer apparatus according to another embodiment of the invention, with the tray thereof shown at its elevated position, with the blade rest disposed in its supporting position and with the handles thereof disposed at upper operative positions;

FIG. 11 is a rear perspective view of the apparatus of FIG. 10, with the tray shown at its lowered position and the handles disposed at storage positions; and

FIG. 12 is rear perspective view of the apparatus of FIG. 10 with the tray shown at its lowered position and the handles disposed at lower operative positions.

### DETAILED DESCRIPTION

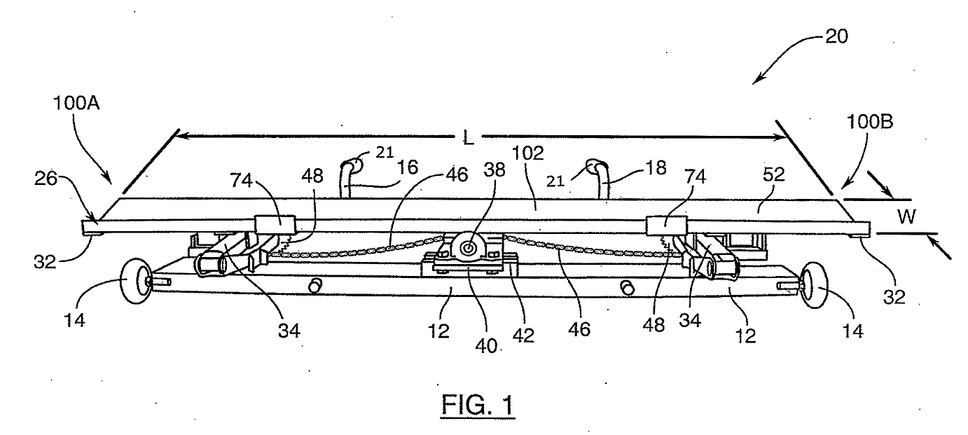

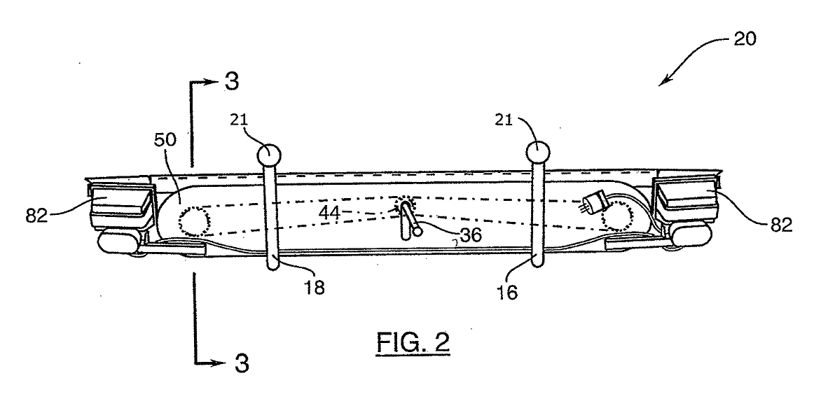

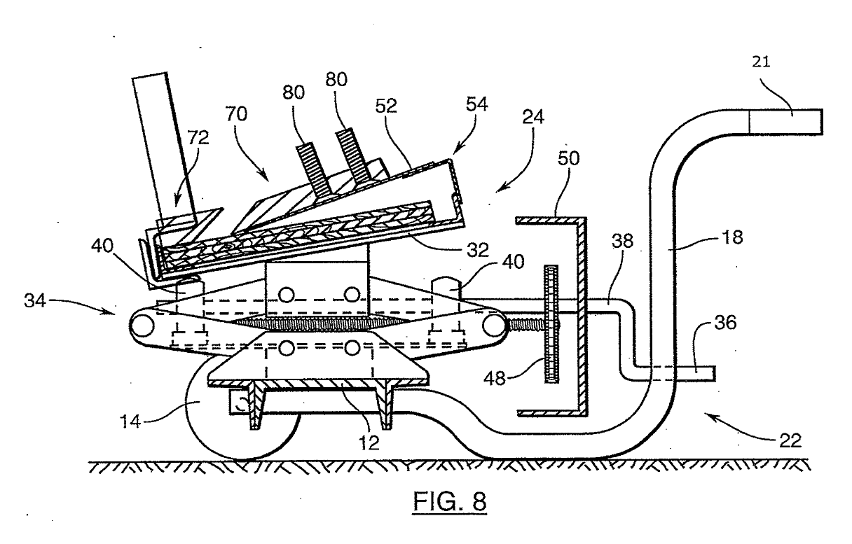

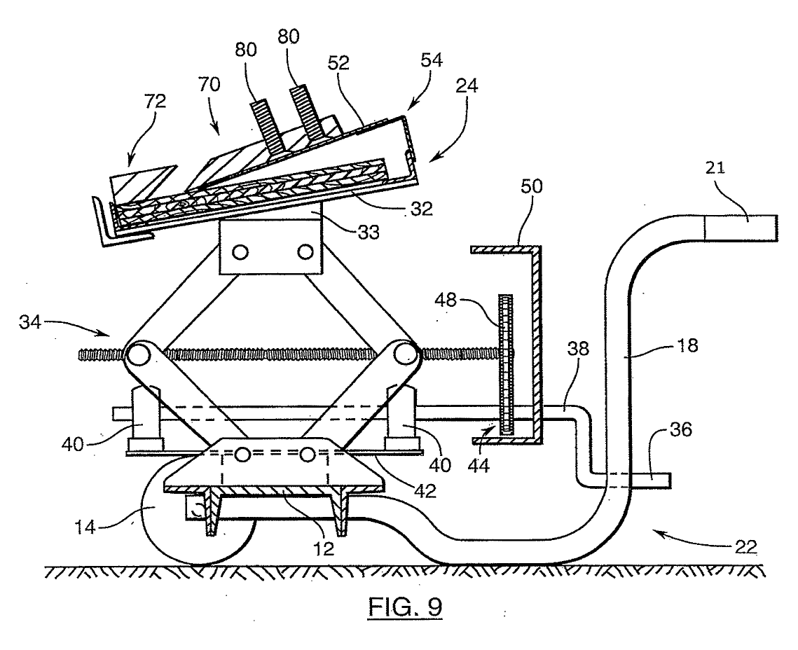

With general reference to FIGS. 1-9, a first preferred embodiment of the present invention, a blade changer apparatus, is illustrated, and is designated by the general reference numeral 20. FIGS. 1 and 2 respectively show front and rear views of the blade changer apparatus 20. Visible in FIG. 1 is a base frame 12 in the form of a steel channel member that extends substantially the width of the blade changer apparatus 20. Mounted on opposite ends of the base frame 12 are two caster wheels 14 upon which the frame 12 can be rolled over a horizontal support surface or floor.

As seen in FIGS. 1-3, rigidly connected to the base frame 12 are two bent handle members 16 and 18 made from metal pipe and extending upwardly and rearwardly from the base frame 12. Mounted on each of these handle members 16, 18 is a rubber hand grip 21. The handle members include a lower bend 22 which forms a ground contact point when the blade changer apparatus 20 is not being moved.

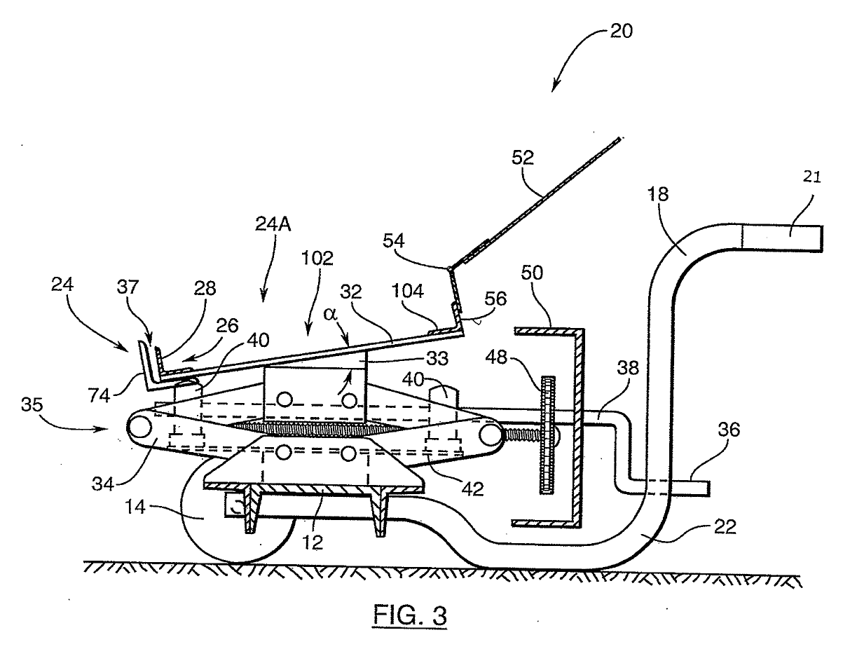

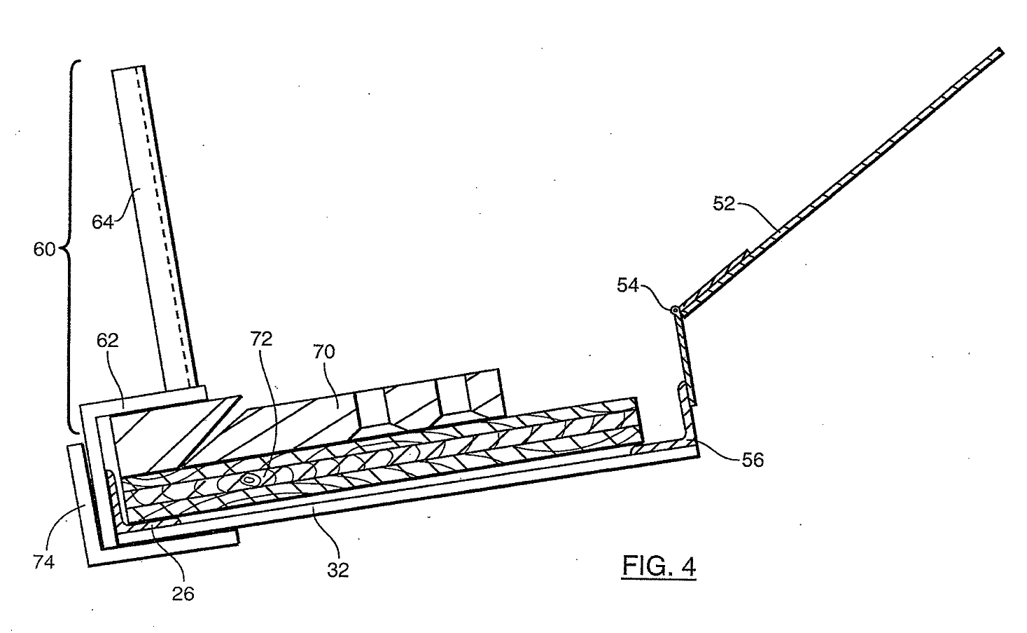

As seen in FIGS. 1-3, the blade changer 20 includes an elongate tray arrangement 24. The tray arrangement 24 includes a blade/sheath holding section 102, an upper side 24A with a length and a width, opposite ends 100A, 100B between which said upper side 24A extends in a horizontal direction and a supporting surface 104 presenting upwardly. This tray arrangement 24 is formed in part by a front angle member 26 which, in a preferred embodiment, is five feet long. This angle member has an upstanding leg 28. The angle member 26 is welded to four horizontally-extending plate supports 32. Two of these plate supports 32 are located at opposite ends of the angle member 26 while the other two are positioned above and mounted on respective scissor jacks 34. As shown, a shim 33 is mounted between the top of each jack 34 and its respective support 32. Each shim 33 has a sloping top that orients the supporting surface 104 at an acute angle α to the horizontal support surface or floor. Angle α as shown is 10°. The scissor jacks 34 are mounted on top of the base frame 12 and together form part of a jack mechanism or arrangement 35. The scissor jacks 34 are jointly actuated by means of a centrally located crank handle 36 that is integrally connected to a horizontal shaft 38 which is rotated by a handle 36. The shaft 38 is rotatably supported by means of two bearing supports 40 mounted by means of bolts to a horizontal support plate 42. The plate 42 is rigidly mounted on top of base frame 12 at the center thereof. As best indicated by FIG. 2, there are mounted on shaft 38 two 12 tooth sprockets 44 which are arranged next to each other on the shaft 38. Extending from each of these sprockets 44 is an endless roller chain 46 with chain portions extending in each direction from the shaft 38, as seen in FIG. 1. Each endless chain 46 extends around a thirty tooth sprocket 48 so that in effect there is about a three to one gear ratio between the drive sprockets 44 and the driven sprockets 48, making rotation of the crank handle 36 relatively easy. Chain, drive sprocket and driven sprockets are shown in FIG. 2 in phantom outline, for greater clarity. It should be noted that, for clarity, only a single driven sprocket 48 and chain 46 are shown in each of FIGS. 3, 7, 8 and 9. As shown in FIG. 2, the chain and sprockets are covered by an elongate chain cover 50 for safety purposes. It will be understood that each sprocket 48 is operatively connected to its respective scissor jack 34 so that rotation of each sprocket 48 will actuate its respective jack. Because each sprocket 48 is operated by the same crank handle 36, the two jacks 34 will be actuated simultaneously. Connected to the rear side of the blade holding section 102 is a pivotable metal flap 52 which is pivotably mounted by means of a piano hinge 54. The piano hinge 54 is connected to the top edge of an upwardly extending leg of a rear angle member 56 which forms the rear side of the blade tray 24. The angle member 56 is rigidly connected (such as by welding) to the rear ends of the four plate supports 32. Another major component of the blade changer apparatus 20 is a stabilizer member 60 which can be completely detached from the rest of the blade changer 20. As seen in FIG. 4, the stabilizer 60 consists of a long angle member 62 and two short angle members 64 which extend perpendicular to the member 62.

To install a blade on an ice resurfacing machine, a sharp blade is procured. Such blades are typically shipped releasably secured to a protective sheath to form a blade/sheath combination, and the first step in such installation is to position said blade/sheath combination in the tray arrangement 24 as shown in FIG. 4, wherein the blade/sheath combination is supported by the tray arrangement, the blade being identified with reference numeral 70 and the two-part sheath by reference numeral 72.

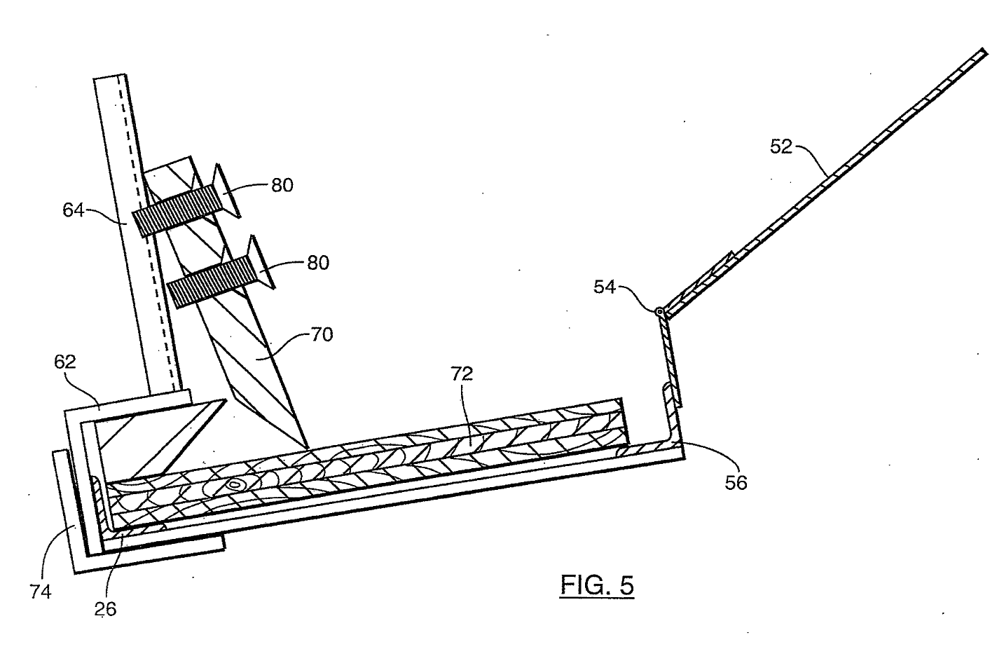

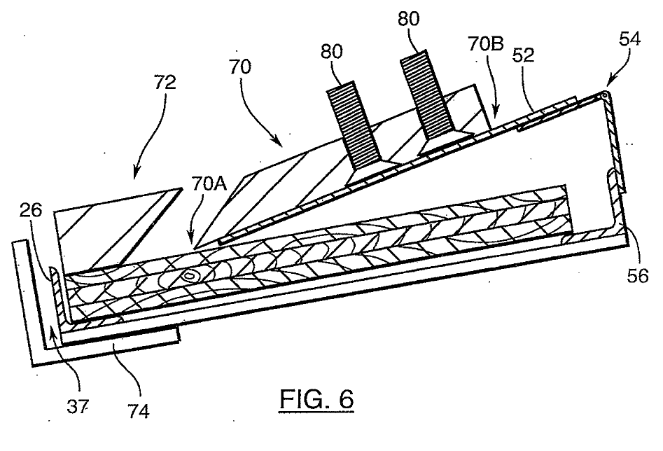

This step may require the initial step of pivoting the flap 52 away from the top of the tray to a non-supporting position, and removal of the stabilizer 60, as indicated in FIG. 3, such that the combination 70/72 can be positioned in the tray 24. When placed in the tray 24, the sharp edge portion of the blade 70 is covered by the protective transportation sheath 72 which typically is made of wood. After the blade 70 has been placed on the tray 24, the stabilizer 60 can be mounted on the tray 24 using two metal support brackets 74 which are rigidly connected on the front side of tray 24. FIG. 4 shows the stabilizer 60 mounted on the tray 24 with the two short angle members 64 extending substantially vertically and the long angle member 62 fitted in a slot 37 (shown in FIG. 3) defined between leg 28 and brackets 74 to form a guard. Mounting bolts (not shown) which hold the protective sheath 72 and blade 70 together for handling are removed, these being located at opposite ends of the sheath 72. The blade 70 is then tipped forwardly against the guard, specifically, against the upright angle members 64 of the stabilizer 60, to the upright position shown in FIG. 5. Angle members 64 are appropriately sized and horizontally spaced-apart from one another, such that, so positioned, the blade can be safely rested. Pliers or other tools may be used for this manipulation. In this position, all of the blade mounting bolts 80 can be installed by inserting them through holes distributed along the length of the blade 70. Once the bolts 80 have been inserted, the metal flap 52 is swung down to its supporting position, onto the wooden sheath 72 which still extends horizontally. In this configuration, the top surface of the flap 52 extends at an angle to the horizontal of 15-30 degrees, corresponding to the correct mounting angle for the blade 70. The relatively heavy blade 70 with bolts 80 is then tipped back down onto the top of the metal flap 52 at which point the stabilizer 60 can be removed. The blade 70 so positioned on the flap 52 is shown in FIG. 6.

So positioned, the blade 70 is arranged on the upper side 24A of the tray arrangement 24 so that the length of the blade 70 extends in the lengthwise direction of the tray arrangement 24, and so that the blade 70, from front 70A to rear 70B edges thereof, extends at an acute angle to the horizontal surface on which the apparatus sits, said angle typically being between 15 and 30 degrees.

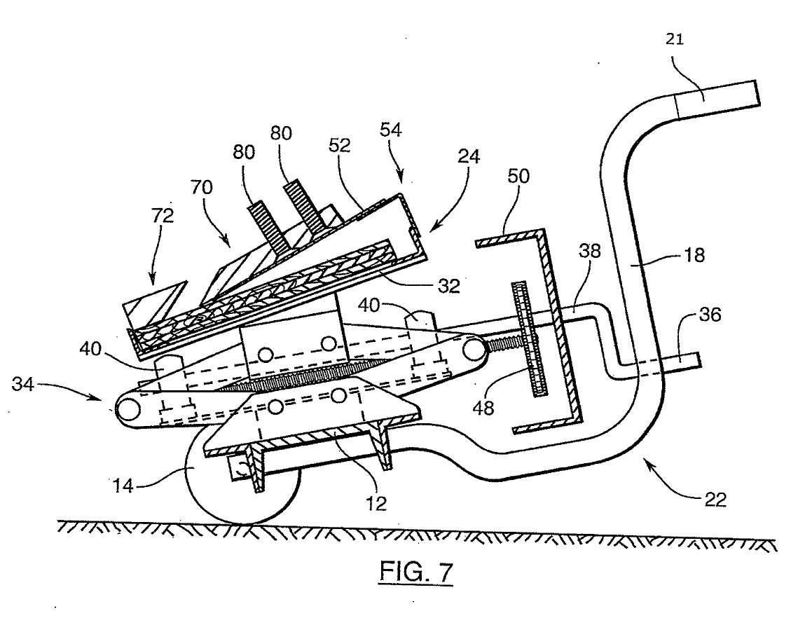

The next step is for the operator to roll the blade changer 20 with the blade 70 thereon under the ice resurfacing machine (not shown). The handles 16,18 can be gripped, and the apparatus 20 moved in the manner of a wheelbarrow for this purpose, as shown in FIG. 7. Thereafter, the crank handle 36 can be turned to actuate the jacks 34 and move the tray arrangement 24, and the blade 70 and sheath 72 supported thereby, upwards. In the operative position of the apparatus 20, the bolts 80 in the blade 70 line up with the mounting holes in the ice surfacing machine as the jack mechanism 35 lifts the tray 24 to its elevated position, such that at the elevated position of the tray 24, the blade 70 is fitted tightly against the mounting bar of the machine, with the mounting bolts 80 extending therethrough. That is, the blade 70 is supported at an acute angle to the horizontal surface on which the apparatus 20 rests and at a suitable height for securing the blade 70 to the machine for use. Lock washers and nuts (not shown) can then be used to connect the blade 70 to the ice conditioning machine. The tray arrangement 24 carrying the now-empty transportation sheath 72 is then lowered to its lowered position by reverse rotation of the crank handle 36, such that the blade changer apparatus 20 can be easily pulled away from beneath the ice conditioning machine. Lamps 82, shown in FIG. 2, which are mounted to the base 12, facilitate mounting and demounting of the blade 70.

The above procedure in reverse can be used to remove a blade from a machine.

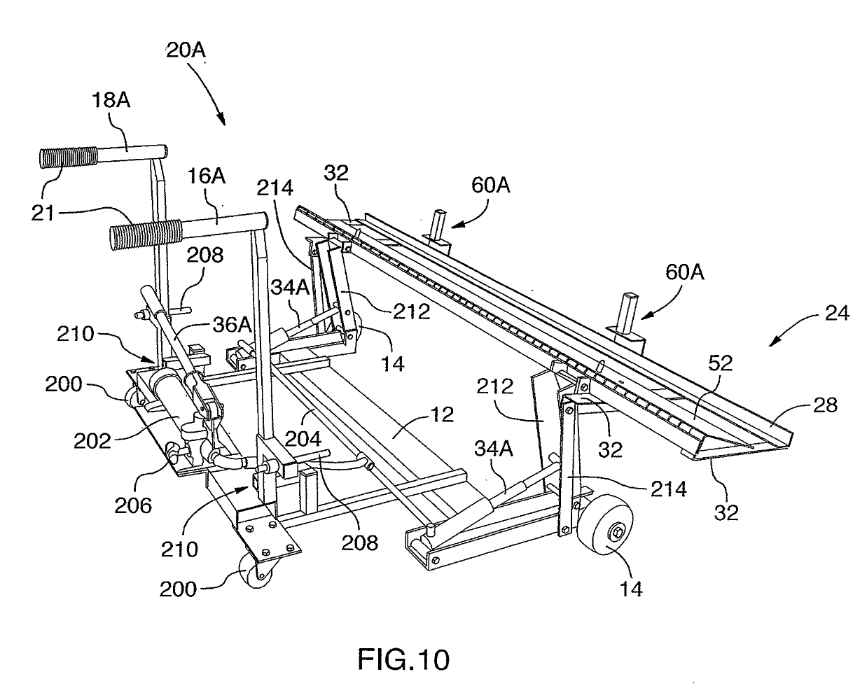

A further embodiment of the invention is shown in FIGS. 10-12 and designated with general reference numeral 20A. This embodiment is similar in construction and operation to the embodiment of FIGS. 1-9, and thus, is not described in detail. However, as will be recognized by persons of ordinary skill, this embodiment is different in certain respects from the embodiment of FIGS. 1-9.

Notably, in contrast to the scissor-style jacks previously illustrated, this embodiment comprises a pair of hydraulic jacks 34A, fluidly coupled to one another by a hydraulic line 204 for joint actuation. A hydraulic pump 202 is coupled to fluid line 204. Pump 202 is operable by pump handle 36A for delivering hydraulic fluid to jacks 34A, for extension thereof, to move the tray arrangement 24 to the elevated position, and a valve 206 is provided to permit hydraulic fluid to be released from the jacks 34A, for movement of the tray arrangement 24 to the lowered position. Each jack 34A is pivotably mounted to base frame 12 and to a parallelogram linkage 212,214 which supports tray arrangement 24, such that extension of the jacks 34A cause pivotal movement of the links 212,214 forming the parallelogram linkage 212,214 and movement of the tray arrangement 24 between the lowered and elevated positions.

A further difference resides in the provision of a pair of rear caster wheels 200 upon which the jack mechanism is supported, such that the apparatus 20A rolls on wheels 14,200 in the manner of a cart.

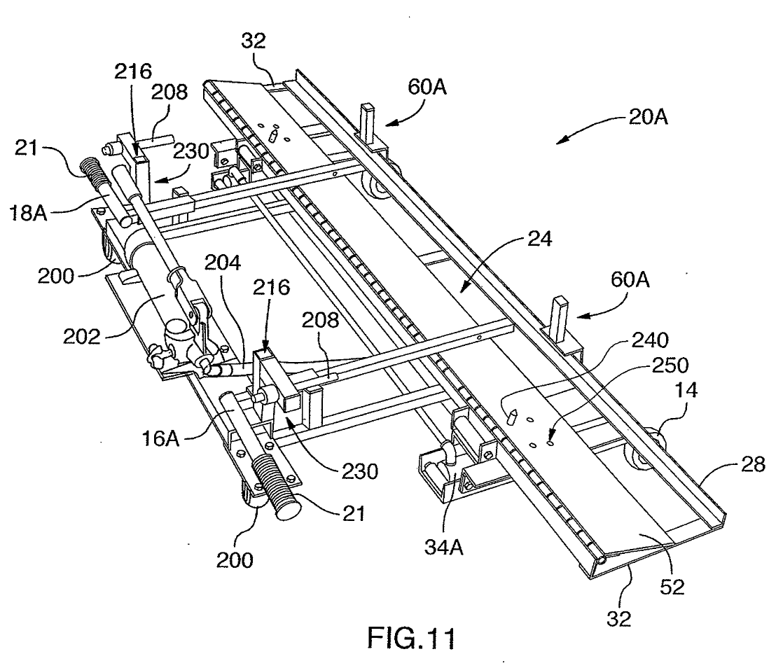

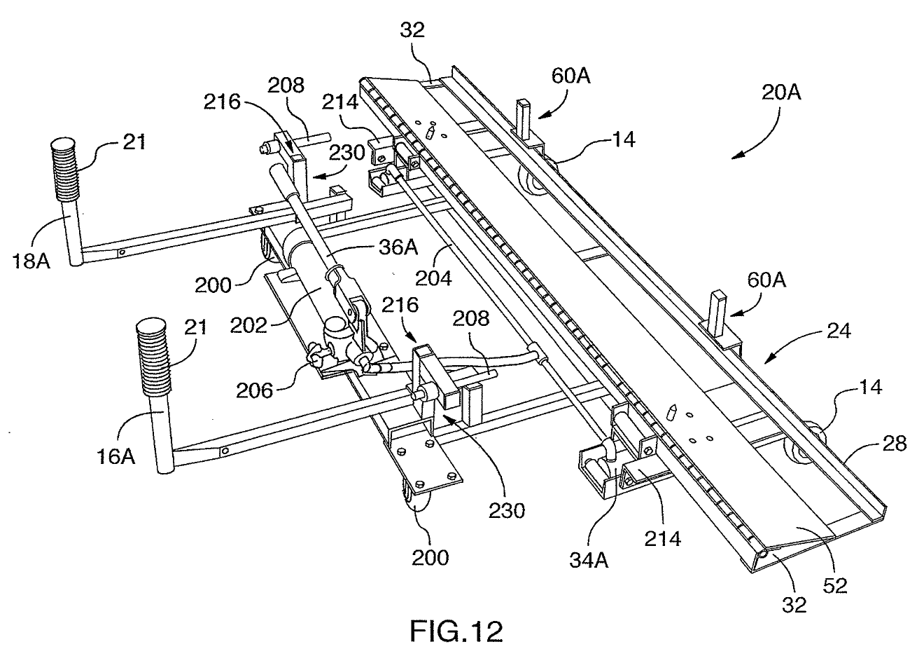

As illustrated in FIG. 10, handles 16A, 18A have a position similar to the position of handles 16, 18 shown in FIG. 3. This represents upper operative positions of the handles 16A, 18A. However, handles 16A, 18A also have storage positions and lower operative positions, shown, respectively, in FIGS. 11 and 12. To provide for this functionality, handles 16A, 18A are defined by L-shaped members, and two pairs of handle-receiving sockets 216 and 210 are provided. When in the upper operative positions, the handles 16A, 18A are fitted into sockets 216 and orientated with grips 21 projecting rearwardly. When in the lower operative positions, handles 16A, 18A are fitted into sockets 210 and orientated with grips 21 projecting upwardly. When in the storage position, the tray arrangement 24 is disposed at its lowered position and the handles 16A, 18A are fitted into sockets 210 and oriented with the grips 21 projecting sideways, away from one another, such that the handles 16A, 18A overly the tray arrangement 24. Pins (not shown) are provided for locking the handles 16A, 18A in the storage, upper operating and lower operation positions, to enhance safety.

The handles 16A, 18A may advantageously be deployed in the lower operative positions if the apparatus 20 is to be used for changing the blade on an ice resurfacing machine having fairly low ground clearance, as it sometimes the case. When in the storage position, the handles 16A, 18A lock the tray arrangement 24 against movement, to permit the apparatus 20 to be pivoted onto its front end, which may be advantageous for storage and transport.

A further difference in the embodiment of FIGS. 10-12 resides in the provision of extendable locating rods 208 which are fitted into bores (not shown) defined in risers 230 in which the sockets 210,216 are defined. The locating rods 208 can be adjusted by a user of the device so as to abut the undercarriage of any given particular ice resurfacing machine when the apparatus is properly positioned for blade exchange, and secured in place with set screws (provided but not identified). Once the locating rods 208 are adjusted and suitable markings have been placed onto the ice surfacing machine, suitable positioning of the blade changing device 20A can be obtained simply by aligning the rod 208 ends with the markings.

A further difference resides in the presence of modified stabilizers 60A which have operative positions as shown in FIGS. 10-12, at which same are releasably locked, and which can be released to pivot (not shown) about a hinge defined on their forward, lower edge. When releasably locked at the position of FIGS. 10-12, modified stabilizers 60A function in a manner identical to stabilizers 60 as shown in FIG. 4. When stabilizers 60A are pivoted forwardly (not shown), apparatus 20A may be positioned beneath the ice resurfacing machine for blade exchange in the manner herein described in detail. The stabilizers 60A are spring-loaded, to avoid inadvertent unlocking, again to enhance safety.

A yet further difference resides in the provision of bolts 240 and a pattern of threaded bores 250 provided in flap 52. In use, the bolts 240 are received in respective mounting holes in the blade, to permit the blade to be positioned at a known location relative to the blade changer. This feature, in combination with the locating rods 208, means that a blade can be conveniently disposed at a position beneath the ice resurfacing machine for blade exchange. The pattern of threaded bores 250 reflects the variances in mounting bolt patterns on commonplace ice resurfacing machines, such that the blade changer apparatus can be easily modified for use therewith.

While but two embodiments of the present invention have been herein shown and described, it will be understood that various changes may be made.

For example, whereas the preferred embodiments illustrated contemplate the tray receiving the blade/sheath combination, the tray could simply receive the blade. This could avoid the need for the blade rest and stabilizers.

As well, a pair of scissor jacks are shown in the described embodiments, but a greater or lesser number of jacks, and jacks of different types, such as pneumatic jacks, could be substituted.

Yet further, whereas the blade rest is shown as a metal plate, it could take other forms, such as a metal framework of bars or the like. As well, whereas it is shown hingedly attached, it could as well be removable. Indeed, the blade rest could be avoided entirely, if the tray arrangement and sheath were suitably shaped and sized so as to avoid interference with the machine mounting bar when the tray arrangement is disposed at the elevated position.

As well, whereas the blade changers shown and described contemplate presentation of the blade at an acute angle to a horizontal plane, the apparatus could be modified to present the blade, for example, in a horizontal orientation.

Further, whereas locating rods are indicated to be fixed in position with set screws, this is not necessary, and variants, such as threaded rods, could be employed.

Accordingly, it should be understood that the invention is to be limited only by the claims appended hereto, purposively construed.

1. A blade changer apparatus for use with an ice resurfacing machine and a blade for said machine, said apparatus comprising:
a tray arrangement for supporting at least said blade; and
a jack mechanism adapted to move the tray arrangement between a lowered position and an elevated position whereat, when said blade is operatively supported by said tray arrangement and said jack mechanism is operatively positioned beneath said machine, said tray arrangement supports said blade substantially at an acute angle to a horizontally extending surface on which said apparatus rests and at a suitable height for securing said blade to said machine for use.

2. An apparatus according to claim 1 wherein said tray arrangement is adapted to support both said blade and a sheath to which said blade is releasably secured for handling, said blade and sheath forming a blade/sheath combination, and wherein, before said tray arrangement is moved to said elevated position, said blade can be detached and separated from said sheath and arranged at said acute angle.

3. Apparatus according to claim 2, wherein said tray arrangement is adapted to permit, when said blade is released from said sheath, said blade to be tipped upright on its edge to an upright position, to permit mounting bolts to be fitted through or removed from said blade.

4. Apparatus according to claim 3, further comprising a stabilizer positionable with respect to the tray arrangement to form a guard against which said blade can be rested when it has been tipped to the upright position.

5. Apparatus according to claim 4, wherein said tray arrangement includes a blade rest movable between:
a supporting position, overlying a supporting surface of a blade/sheath holding section of the tray arrangement, at which position, the blade can be tipped downwardly from the upright position and at which position the blade rest supports said blade in an angular orientation relative to horizontal such that, when the jack mechanism is operatively positioned beneath said machine and the tray arrangement is raised to the elevated position, said blade is disposed substantially at the position the blade occupies when secured to said machine in use; and
a non-supporting position where the blade rest does not extend over the holding section, wherein said blade/sheath combination can be placed flat on said holding section when the blade rest is in its non-supporting position.

6. Apparatus according to claim 5, wherein the blade rest is hingedly secured to said holding section for movement between its supporting and non-supporting positions.

7. Apparatus according to claim 1, wherein the jack mechanism comprises a pair of scissor jacks, mechanically coupled to one another for joint actuation in order to move the tray arrangement between said lowered position and said elevated position.

8. Apparatus according to claim 1, wherein the jack mechanism comprises a pair of hydraulic jacks, fluidly coupled to one another for joint actuation in order to move the tray arrangement between said lowered position and said elevated position.

9. Apparatus according to claim 1, wherein said jack mechanism is provided with wheels and handles and is adapted for rolling movement in the manner of a wheelbarrow.

10. Apparatus according to claim 9, wherein said handles and said wheels support said jack mechanism in its operative position.

11. Apparatus according to claim 1, wherein the jack mechanism is provided with wheels and handles and is adapted for rolling movement in the manner of a cart.

12. Apparatus according to claim 11, wherein the wheels support said jack mechanism in its operative position.

13. A blade changer apparatus for mounting an elongate blade on an ice resurfacing machine, said apparatus comprising:
a wheeled base frame for movement across a horizontally extending surface;
an elongate tray arrangement for supporting the blade, said tray arrangement including an upper side, with a length and a width, and having opposite ends between which said upper side extends in a horizontal direction, said blade being arranged on said upper side so that the length of said blade extends in the lengthwise direction of said tray arrangement during use of said apparatus, said tray arrangement being capable of supporting said blade during use of the apparatus so that the blade from front to rear edges thereof extends at an acute angle to a horizontal plane at which angle said blade is suitably orientated for attachment to said machine; and
a jack arrangement mounted on said base frame and supporting said tray arrangement, said jack arrangement being adapted to move the tray arrangement between a lowered position at which the blade can be arranged on said tray arrangement at said acute angle to a horizontal plane, and an elevated position at which said blade can be secured to said machine when said apparatus is operatively positioned beneath said machine.

14. An apparatus according to claim 13, wherein said tray arrangement includes a blade rest movable between a blade supporting position overlying said upper side and a non-supporting position where the blade rest does not extend over said upper side and wherein, during use of said apparatus, said blade can be placed on top of the blade rest when the latter is in said supporting position and thereby orientated at said acute angle for attachment to said machine.

15. An apparatus according to claim 14, wherein said tray arrangement includes a blade holding section which is mounted on and connected to said jack arrangement and said blade rest is hingedly secured to a rear side of said blade holding section for pivotal movement between its supporting and non-supporting positions.

16. An apparatus according to claim 13, wherein said acute angle is less than 30 degrees.

17. An apparatus according to claim 13, wherein said base frame is elongate in a direction extending between left and right ends thereof, and said jack arrangement comprises a pair of spaced-apart jacks operatively coupled to a single drive mechanism for joint actuation, each jack being positioned adjacent a respect one of said left and right ends.

18. A blade changer apparatus for mounting an elongate blade on a machine, said apparatus comprising:
a wheeled support frame adapted for movement over a horizontally extending surface;
a tray arrangement adapted for supporting said blade and a sheath to which said blade is releasably secured for transport and handling purposes, said blade and sheath together forming a blade/sheath combination;
said tray arrangement including a holding section having a upper side extending horizontally between left and right ends of the holding section and adapted to hold said blade/sheath combination and a blade rest movable between a blade supporting position where the blade rest overlies said upper side, extends at an acute angle to said horizontally extending surface, and can be used to support said blade at said acute angle during the mounting of the blade on said machine, and a non-supporting position where the blade rest does not overlie said upper side; and
a jack arrangement mounted on said support frame and adapted to support said tray arrangement, said jack arrangement being connected to said holding section and capable of moving said tray arrangement between a lowered position at which said blade/sheath combination can be arranged on said holding section, and an elevated position used for securing said blade to said machine.

19. An apparatus according to claim 18 wherein said blade rest is hingedly secured to a rear side of said holding section and is pivotable between said blade supporting position and said non-supporting position.

20. An apparatus according to claim 18 including a stabilizer detachably mountable on a front side of said holding section, said stabilizer in use providing a vertically extending support against which said blade can be rested when said blade is pivoted to an upright position in order to insert mounting bolts through holes on the blade.

21. An apparatus according to claim 18 wherein said jack arrangement includes a pair of spaced-apart scissor jacks and a continuous drive chain and crank arrangement for operating said scissor jacks simultaneously.

22. An apparatus according to claim 18, wherein said acute angle to said horizontally extending surface is in the range of 15 to 30 degrees with said wheeled support frame resting on the horizontally extending surface.

23. An apparatus according to claim 18, wherein said support frame has two wheels mounted at opposite ends thereof and is provided with handles that extend rearwardly and upwardly from the support frame, whereby said apparatus is adapted for rolling movement in a manner similar to that of a wheelbarrow.
